(19) United States
(12) Patent Application Publication
(10) Pub. No.: US 2023/0209125 A1
(43) Pub. Date: Jun. 29, 2023

(54) METHOD FOR DISPLAYING INFORMATION AND COMPUTER DEVICE

(71) Applicant: BEIJING DAJIA INTERNET INFORMATION TECHNOLOGY CO., LTD., Beijing (CN)

(72) Inventors: Yanting LIU, Beijing (CN); Kaijie CHEN, Beijing (CN); Yulin SONG, Beijing (CN); Cheng XU, Beijing (CN); Xiang LI, Beijing (CN); Ximing CHEN, Beijing (CN); Wenya WU, Beijing (CN)

(21) Appl. No.: 17/816,092

(22) Filed: Jul. 29, 2022

(30) Foreign Application Priority Data
Dec. 29, 2021 (CN) 202111643573.2

(51) Int. Cl. H04N 21/431; H04N 21/2187; H04N 21/466; H04N 21/478

(52) U.S. Cl. CPC H04N 21/4316; H04N 21/2187; H04N 21/4668; H04N 21/47815

(57) ABSTRACT

A method for displaying information is provided. The method includes: receiving a video data stream for displaying a first video related to a virtual space and recommending the virtual space; displaying the first video related to the virtual space based on the video data stream; and displaying recommendation information of the virtual space on the first video related to the virtual space, wherein the recommendation information is determined based on a live streaming goal of the virtual space, the live streaming goal indicating an effect to be achieved by live streaming.

### CROSS-REFERENCE TO RELATED APPLICATION

This application is based on and claims priority to Chinese Patent Application No. 202111643573.2, filed on Dec. 29, 2021, the disclosure of which is herein incorporated by reference in its entirety.

### TECHNICAL FIELD

The present disclosure relates to the field of Internet technologies, and in particular to a method for displaying information and a computer device.

### BACKGROUND

In the field of live streaming technologies, for increasing the popularity of a virtual space (e.g., a live streaming room), an anchor usually recommends the virtual space to other users to attract more users to enter the virtual space.

### SUMMARY

The present disclosure provides a method for displaying information and a computer device. The technical solutions of the present disclosure are as follows.

According to one aspect, a method for displaying information is provided. The method includes:

receiving a video data stream for displaying a first video related to a virtual space and recommending the virtual space;

displaying the first video related to the virtual space based on the video data stream; and

displaying recommendation information of the virtual space on the first video related to the virtual space, wherein the recommendation information is determined based on a live streaming goal of the virtual space, the live streaming goal indicating an effect to be achieved by live streaming.

According to another aspect, a method for displaying information is provided. The method includes:

acquiring a live streaming goal of a virtual space, wherein the live streaming goal indicates an effect to be achieved by live streaming;

determining recommendation information of the virtual space based on the live streaming goal of the virtual space; and

sending a video data stream of the virtual space to a terminal, wherein the video data stream carries the recommendation information, to trigger the terminal, based on the video data stream, to display a first video related to the virtual space and display the recommendation information of the virtual space on the first video related to the virtual space, the video data stream being used for recommending the virtual space.

According to yet another aspect, an apparatus for displaying information is provided. The apparatus includes:

a receiving unit, configured to receive a video data stream for displaying a first video related to a virtual space and recommending the virtual space;

a video displaying unit, configured to display the first video related to the virtual space based on the video data stream; and

an information displaying unit, configured to display recommendation information of the virtual space on the first video related to the virtual space, wherein the recommendation information is determined based on a live streaming goal of the virtual space, the live streaming goal indicating an effect to be achieved by live streaming.

According to yet another aspect, an apparatus for displaying information is provided. The apparatus includes:

an acquiring unit, configured to acquire a live streaming goal of a virtual space, wherein the live streaming goal indicates an effect to be achieved by live streaming;

a determining unit, configured to determine recommendation information of the virtual space based on the live streaming goal of the virtual space; and

a sending unit, configured to send a video data stream of the virtual space to a terminal, wherein the video data stream carries the recommendation information, to trigger the terminal, based on the video data stream, to display a first video related to the virtual space and display the recommendation information of the virtual space on the first video related to the virtual space, wherein the video data stream is used for recommending the virtual space.

According to yet another aspect, a computer device is provided. The computer device includes:

one or more processors; and

a memory configured to store one or more program codes executable by the one or more processors,

wherein the one or more processors, when loading and executing the program codes, are configured to:

receive a video data stream for displaying a first video related to a virtual space and recommending the virtual space;

display the first video related to the virtual space based on the video data stream; and

display recommendation information of the virtual space on the first video related to the virtual space, wherein the recommendation information is determined based on a live streaming goal of the virtual space, the live streaming goal indicating an effect to be achieved by live streaming.

According to yet another aspect, a computer device is provided. The computer device includes:

one or more processors; and

a memory configured to store one or more program codes executable by the one or more processors,

wherein the one or more processors, when loading and executing the program codes, are configured to:

acquire a live streaming goal of a virtual space, wherein the live streaming goal indicates an effect to be achieved by live streaming;

determine recommendation information of the virtual space based on the live streaming goal of the virtual space; and

send a video data stream of the virtual space to a terminal, wherein the video data stream carries the recommendation information, to trigger the terminal, based on the video data stream, to display a first video related to the virtual space and display the recommendation information of the virtual space on the first video related to the virtual space, the video data stream being used for recommending the virtual space.

According to yet another aspect, a computer-readable storage medium is provided. The computer-readable storage medium stores one or more program codes. The program codes, when loaded and executed by a processor of a computer device, cause the computer device to:

receive a video data stream for displaying a first video related to a virtual space and recommending the virtual space;

display the first video related to the virtual space based on the video data stream; and

display recommendation information of the virtual space on the first video related to the virtual space, wherein the recommendation information is determined based on a live streaming goal of the virtual space, the live streaming goal indicating an effect to be achieved by live streaming.

According to yet another aspect, a computer-readable storage medium is provided. The computer-readable storage medium stores one or more program codes. The program codes, when loaded and executed by a processor of a computer device, cause the computer device to:

acquire a live streaming goal of a virtual space, wherein the live streaming goal indicates an effect to be achieved by live streaming;

determine recommendation information of the virtual space based on the live streaming goal of the virtual space; and

send a video data stream of the virtual space to a terminal, wherein the video data stream carries the recommendation information, to trigger the terminal, based on the video data stream, to display a first video related to the virtual space and display the recommendation information of the virtual space on the first video related to the virtual space, the video data stream being used for recommending the virtual space.

According to yet another aspect, a computer program product is provided. The computer program product includes a computer program. The computer program, when loaded and executed by a processor of a device, causes the device to:

receive a video data stream for displaying a first video related to a virtual space and recommending the virtual space;

display the first video related to the virtual space based on the video data stream; and

display recommendation information of the virtual space on the first video related to the virtual space, wherein the recommendation information is determined based on a live streaming goal of the virtual space, the live streaming goal indicating an effect to be achieved by live streaming.

According to yet another aspect, a computer program product is provided. The computer program product includes a computer program. The computer program, when loaded and executed by a processor of a device, causes the device to:

acquire a live streaming goal of a virtual space, wherein the live streaming goal indicates an effect to be achieved by live streaming;

determine recommendation information of the virtual space based on the live streaming goal of the virtual space; and

send a video data stream of the virtual space to a terminal, wherein the video data stream carries the recommendation information, to trigger the terminal, based on the video data stream, to display a first video related to the virtual space and display the recommendation information of the virtual space on the first video related to the virtual space, the video data stream being used for recommending the virtual space.

### BRIEF DESCRIPTION OF THE DRAWINGS

FIG. 1 is a schematic diagram of an implementation environment of a method for displaying information according to an embodiment of the present disclosure;

FIG. 2 is a flowchart of a method for displaying information according to an embodiment of the present disclosure;

FIG. 3 is a flowchart of a method for displaying information according to an embodiment of the present disclosure;

FIG. 4 is a flowchart of a method for displaying information according to an embodiment of the present disclosure;

FIG. 5 is a schematic diagram of a first video according to an embodiment of the present disclosure;

FIG. 6 is a schematic diagram of a first video according to an embodiment of the present disclosure;

FIG. 7 is a schematic diagram of a first video according to an embodiment of the present disclosure;

FIG. 8 is a schematic diagram of a first video according to an embodiment of the present disclosure;

FIG. 9 is a schematic diagram of a first video according to an embodiment of the present disclosure;

FIG. 10 is a block diagram of an apparatus for displaying information according to an embodiment of the present disclosure;

FIG. 11 is a block diagram of an apparatus for displaying information according to an embodiment of the present disclosure;

FIG. 12 is a block diagram of a terminal according to an embodiment of the present disclosure; and

FIG. 13 is a block diagram of a server according to an embodiment of the present disclosure.

### DETAILED DESCRIPTION

In order to make those skilled in the art better understand the technical solutions provided by the present disclosure, the technical solutions in the embodiments of the present disclosure are clearly and completely described hereafter with reference to the accompanying drawings.

The data or information in the present disclosure is authorized by a user or fully authorized by all parties.

At present, an anchor usually calls on users to enter a virtual space to view by recommending a promotional video of the virtual space to the users. However, the recommendation effect for the virtual space of the above recommendation manner is poor. Therefore, a novel recommendation manner for the virtual space is urgently needed to improve the recommendation effect for the virtual space.

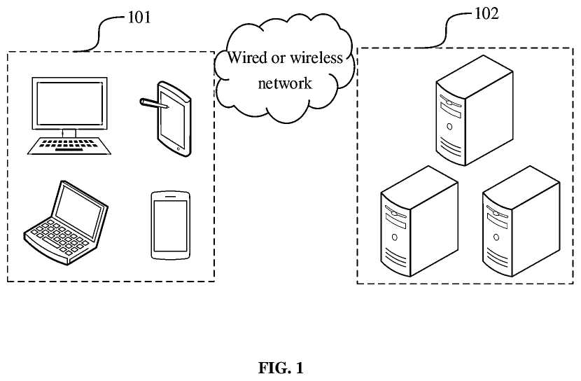

FIG. 1 is a schematic diagram of an implementation environment of a method for displaying information according to an embodiment of the present disclosure. Referring to FIG. 1, the implementation environment includes a terminal 101 and a server 102.

The terminal 101 may be at least one of devices such as a smart phone, a smart watch, a desktop computer, a laptop computer, a virtual reality terminal, an augmented reality terminal, a wireless terminal, and a laptop portable computer. The terminal 101 has a communication function and may access a wired or wireless network. The terminal 101 may generally refer to one of a plurality of terminals, and embodiments of the present disclosure are illustrated by taking terminal 101 as an example. A person skilled in the art may know that there may be more or fewer terminals.

In some embodiments, terminal 101 runs an application with a video playing function and a video live streaming function, such as a live streaming application, a social application, or a short video application. In some embodiments, the terminal 101 is configured to receive a video data stream, display a first video related to a virtual space based on the video data stream, and display recommendation information of the virtual space on the first video related to the virtual space, wherein the video data stream is used for recommending the virtual space, and the virtual space is a live streaming room. In some embodiments, terminal 101 is further configured to receive a live streaming data stream and display a second video related to the virtual space based on the live streaming data stream.

The server 102 may be an independent physical server, a server cluster including multiple physical servers, a distributed file system, or a cloud server providing a basic cloud computing service such as a cloud service, a cloud database, cloud computing, a cloud function, cloud storage, a network service, a cloud communication, a middleware service, a domain name service, a security service, a Content Delivery Network (CDN), big data, and an artificial intelligence platform.

In some embodiments, the server 102 may be a background server for an application ran by the terminal 101 and may be configured to provide a background service for the application run by the terminal 101. In some embodiments, the server 102 may be directly or indirectly connected to the terminal 101 through wired or wireless communication, which is not limited in this embodiment of the present disclosure.

In some embodiments, the server 102 is configured to acquire a live streaming goal of a virtual space, determine, based on the live streaming goal of the virtual space, recommendation information of the virtual space, and send a video data stream of the virtual space to the terminal 101, to trigger the terminal 101, based on the video data stream, to display a first video related to the virtual space and display the recommendation information of the virtual space on the first video related to the virtual space.

In some embodiments, there may be more or fewer servers 102, which is not limited in this embodiment of the present disclosure. Certainly, the server 102 may further include other functional servers to provide more comprehensive and diversified services.

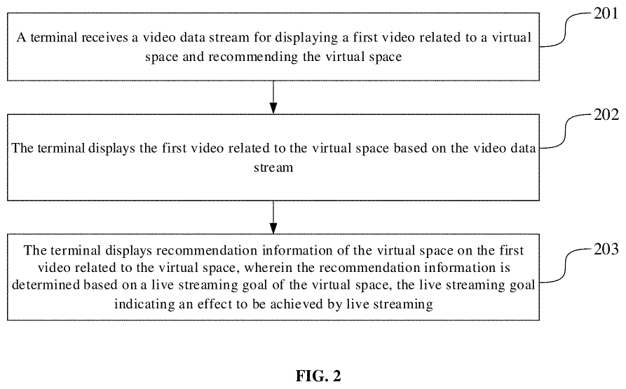

FIG. 2 is a flowchart of a method for displaying information according to an embodiment of the present disclosure. As shown in FIG. 2, taking that the method is applicable to a terminal as an example, the method includes the following processes.

In process 201, the terminal receives a video data stream for displaying a first video related to a virtual space and recommending the virtual space.

In process 202, the terminal displays the first video related to the virtual space based on the video data stream.

In process 203, the terminal displays recommendation information of the virtual space on the first video related to the virtual space, wherein the recommendation information is determined based on a live streaming goal of the virtual space, the live streaming goal indicating an effect to be achieved by live streaming.

In the technical solutions according to this embodiment of the present disclosure, in the case that video data streams of a virtual space are recommended to a user, recommendation information corresponding to a live streaming goal of the virtual space is displayed for the user based on the live streaming goal. Therefore, a recommending method for the virtual space based on the live streaming goal is provided. Different pieces of recommendation information can be displayed for the user based on different live streaming goals. Thus, the amount of displayed information is increased, and the displayed recommendation information can better match with the live streaming goal of the virtual space. Therefore, the recommendation effect for the virtual space is improved.

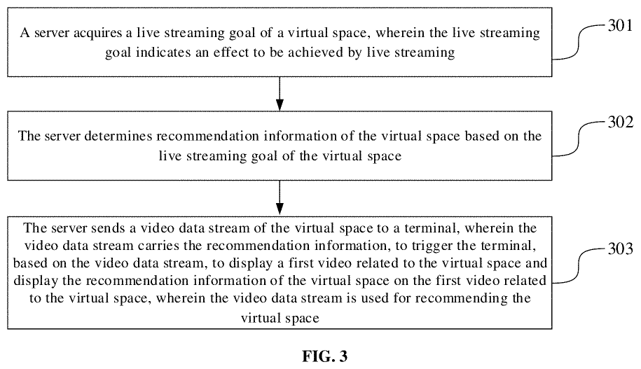

FIG. 3 is a flowchart of a method for displaying information according to an embodiment of the present disclosure. As shown in FIG. 3, taking that the method is applicable to a server as an example, the method includes the following processes.

In process 301, the server acquires a live streaming goal of a virtual space, wherein the live streaming goal indicates an effect to be achieved by live streaming.

In process 302, the server determines, based on the live streaming goal of the virtual space, recommendation information of the virtual space.

In process 303, the server sends a video data stream of the virtual space to a terminal, wherein the video data stream carries the recommendation information, to trigger the terminal, based on the video data stream, to display a first video related to the virtual space and display the recommendation information of the virtual space on the first video related to the virtual space, wherein the video data stream is used for recommending the virtual space.

In the technical solutions according to this embodiment of the present disclosure, in the case that video data streams of a virtual space are recommended to a user, recommendation information corresponding to a live streaming goal of the virtual space is displayed for the user based on the live streaming goal. Therefore, a recommending method for the virtual space based on the live streaming goal is provided. Different pieces of recommendation information can be displayed for the user based on different live streaming goals. Thus, the amount of displayed information is increased, and the displayed recommendation information can better match with the live streaming goal of the virtual space. Therefore, the recommendation effect for the virtual space is improved.

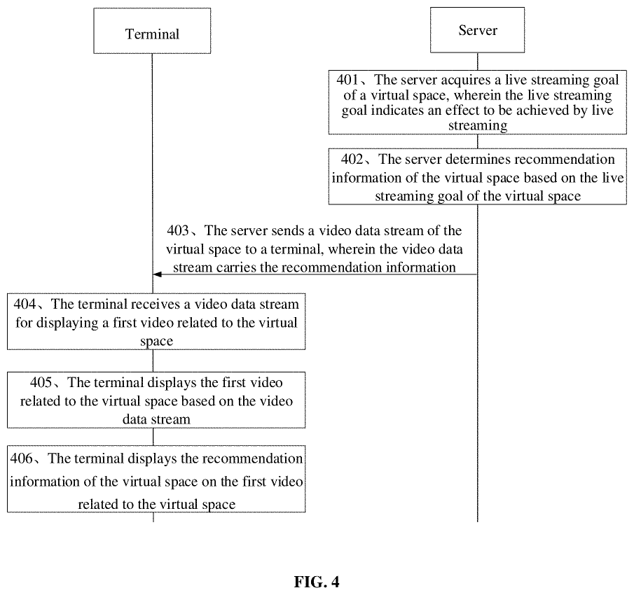

FIG. 2 and FIG. 3 show merely basic flows of the present disclosure. The following further describes the solution of the present disclosure based on a specific embodiment. FIG. 4 is a flowchart of a method for displaying information according to an embodiment of the present disclosure. Referring to FIG. 4, The method includes the following processes.

In process 401, a server acquires a live streaming goal of a virtual space, wherein the live streaming goal indicates an effect to be achieved by live streaming.

The virtual space is a live streaming room. In some embodiments, the virtual space is represented by a space identifier, for example, a live streaming room name, a live streaming room number, or a live streaming room identity (ID). In some embodiments, the live streaming goal indicates an effect to be achieved by the live streaming.

In some embodiments, the live streaming goal includes any one of a live streaming goal to increase a degree of interest in an anchor of the virtual space, and a live streaming goal to increase a quantity of viewers in the virtual space. The anchor is an anchor user (or referred to as an anchor account). Increasing the degree of interest in the anchor of the virtual space means increasing a quantity of fans of the anchor of the virtual space. Increasing the quantity of viewers in the virtual space means increasing a quantity of online viewers in the virtual space. This embodiment of the present disclosure is described hereafter by taking that the live streaming goal is to increase the degree of interest in the anchor of the virtual space or increase the quantity of viewers in the virtual space as an example. Certainly, the live streaming goal may further include goals of other types, for example, to increase a viewing times for a specific type of target item in the virtual space, which is not limited in this embodiment of the present disclosure.

In some embodiments, in response to receiving a recommendation request for the virtual space, the server performs the above process of acquiring the live streaming goal of the virtual space; or in the case that the virtual space is in live streaming, the server automatically performs the above process of acquiring the live streaming goal of the virtual space. A trigger condition for acquiring the live streaming goal by the server is not limited in this embodiment of the present disclosure.

For the process of acquiring the live streaming goal of the virtual space by the server, reference is made to any one of process 401A and process 401B.

In some embodiments (process 401A), the server acquires, based on a space identifier of the virtual space, a live streaming goal corresponding to the space identifier from first relationship data, and determines the acquired live streaming goal as the live streaming goal of the virtual space, wherein the first relationship data indicates a corresponding relationship between the space identifier and the live streaming goal. The space identifier of the virtual space is a live streaming room identifier of the live streaming room.

In this embodiment, by setting the first relationship data, the server can rapidly determine, based on the space identifier of the virtual space and the first relationship data, the live streaming goal of the virtual space, thereby improving the efficiency of acquiring the live streaming goal.

In some embodiments, prior to implementing this solution, the anchor may set the live streaming goal of the virtual space, and upload the set live streaming goal to the server, to trigger the server to correspondingly store the space identifier of the virtual space and the set live streaming goal into the first relationship data, such that the server can subsequently acquire the live streaming goal of the virtual space based on the first relationship data. For example, the live streaming goal of the anchor is to increase an interest in the anchor. Upon the anchor uploading the live streaming goal to the server, the server creates the first relationship data based on the space identifier of the virtual space and the live streaming goal, such that the server can subsequently acquire, based on the space identifier of the virtual space, the corresponding live streaming goal via mapping based on the first relationship data.

In some embodiments (process 401B), the server acquires the live streaming goal of the virtual space by performing image recognition on a second video related to the virtual space, wherein the second video is acquired based on a live streaming data stream of the virtual space.

The second video is a video displayed based on the live streaming data stream, namely, a live streaming video related to the virtual space. The image recognition is a technology for processing, analyzing, and recognizing an image by using a computer recognition technology.

In some embodiments, the server performs image recognition on the second video related to the virtual space using an image recognition model. A corresponding process includes: the server inputs an image in the second video related to the virtual space into the image recognition model, and acquires the live streaming goal of the virtual space based on the image recognition model. For example, the server inputs the image in the second video into the image recognition model, and acquires an image feature of the image in the second video by performing feature extraction on the image in the second video based on the image recognition model. The server acquires a live streaming goal corresponding to the second video by performing classification based on the image feature of the image in the second video and the image recognition model. In this way, the live streaming goal of the virtual space is acquired based on the image recognition model, thereby improving the efficiency and accuracy of acquiring the live streaming goal.

In some embodiments, the image recognition model is acquired via training based on a plurality of sample images and live streaming goals of the plurality of sample images. In some embodiments, the server acquires a plurality of sample images and live streaming goals of the plurality of sample images, and acquires the image recognition model by performing model training based on the plurality of sample images and the live streaming goals of the plurality of sample images. Specifically, the training process of the image recognition model includes: acquiring a target recognition result of a first iteration by separately inputting the plurality of sample images into an initial model during the first iteration; determining a loss function based on the target recognition result of the first iteration process and the live streaming goals of the sample images, and adjusting a model parameter in the initial model based on the loss function; performing a second iteration by taking the adjusted model parameter upon the first iteration as a model parameter of the second iteration; repeating the above iteration process for a plurality of times until a training condition is met, wherein model training in an N^{th} iteration is performed by taking an adjusted model parameter upon an (N−1)^{th} iteration as a new model parameter; and acquiring and determining a model corresponding to an iteration meeting the training condition as the image recognition model. N is a positive integer and is greater than 1. In some embodiments, the training condition is that a quantity of training iterations of the initial model reaches a target quantity, wherein the target quantity is a predetermined quantity of training iterations; or the training condition is that a loss value meets a target threshold condition, for example, the loss value is less than 0.00001. The setting of the training condition is not limited in this embodiment of the present disclosure. The objectives of training the image recognition model are to establish a mapping relationship between an image and a live streaming goal, and determine a live streaming goal corresponding to an image that does not exist during training based on a generalization ability of the image recognition model.

In the above embodiments, the server automatically performs image recognition on the image in the second video to acquire the live streaming goal of the virtual space, which improves efficiency and precision of acquiring the live streaming goal.

In process 402, the server determines, based on the live streaming goal of the virtual space, recommendation information of the virtual space.

The recommendation information is information related to the virtual space and displayed during the recommendation of the virtual space, namely, information of the live streaming room displayed during the recommendation of the live streaming room; or the recommendation information is used for recommending the virtual space.

In some embodiments, the server acquires, based on the live streaming goal of the virtual space, an information type corresponding to the live streaming goal from second relationship data, and acquires recommendation information of the acquired information type of the virtual space, wherein the information type indicates a type of recommendation information to be determined, and the second relationship data indicates a corresponding relationship between the live streaming goal and the information type. In this embodiment, by setting the second relationship data, the server can rapidly determine, based on the live streaming goal of the virtual space and the second relationship data, the type of recommendation information to be determined, and then acquire the recommendation information based on the determined information type, thereby improving efficiency of acquiring the recommendation information.

A process of acquiring the recommendation information by the server is described based on the two live streaming goals in process 401: to increase a degree of interest in the anchor of the virtual space and to increase the quantity of viewers in the virtual space. The corresponding processes may refer to process 402A and process 402B.

In some embodiments (process 402A), in a case that the live streaming goal is to increase a degree of interest in the anchor of the virtual space, taking the information type indicating a follow control for the anchor as an example, accordingly, the server generates first recommendation information based on the follow control for the anchor, wherein the first recommendation information is to display the follow control on the first video related to the virtual space, and the follow control is used to trigger a follow on the anchor of the virtual space.

In some embodiments (process 402B), in a case that the live streaming goal is to increase the quantity of viewers in the virtual space, taking the information type indicating a view control for a target item as an example, accordingly, the server generates second recommendation information based on the view control for the target item, wherein the second recommendation information is to display the view control for the target item in the virtual space on the first video related to the virtual space, and the view control is used to trigger the display of the target item in the virtual space.

In some embodiments, the virtual space is provided with at least one item. The item is a product or service provided in the virtual space. The target item is an item to be recommended. In some embodiments, the target item is at least one of the following items provided in the virtual space: an item matching with an object logged in to the terminal, an item being introduced in the virtual space, and an item meeting a target condition in the virtual space. The object logged in to the terminal is a user account logged in to the terminal.

Accordingly, the server further acquires, from the at least one item provided in the virtual space, at least one of the item matching with the object logged in to the terminal, the item being introduced in the virtual space, and the item meeting the target condition in the virtual space; and determines the acquired item as the target item.

In some embodiments, the item matching with the object logged in to the terminal is an item matching with attribute information of the user account, for example, an item carrying a same tag as the user account. In some other embodiments, the item matching with the object logged in to the terminal is an item matching with behavior information of the user account, for example, an item with which the user interacted, which is an item taped by the user during a browsing process. The target condition is a predetermined fixed condition. For example, the item meeting the target condition may be an item of a target type, for example, an item of a discount type; or may be an item whose item transaction resource meets a resource quantity condition. In some embodiments, the resource quantity condition is that a quantity of the item transaction resources is less than or equal to a transaction resource threshold; or the resource quantity condition is that the quantity of the item transaction resources is minimum, for example, an item with a low price. Alternatively, the item meeting the target condition may be an item whose transaction quantity meets a transaction quantity condition. In some embodiments, the transaction quantity condition is that the transaction quantity is greater than or equal to a transaction quantity threshold; or the transaction quantity condition is that the transaction quantity is maximum, for example, an item with high sales.

In the above embodiments, a plurality of manners for selecting the target item are provided, such that flexibility of determining the target item is improved.

Further, either different virtual spaces or a same virtual space may provide different types of items. In this case, the server further acquires, based on the type of the target item, a view control corresponding to the type of the target item. In some embodiments, the target item is at least one of a transaction-type item, a download-type item, and a consultation-type item. The transaction-type item is an item used for transaction, for example, a commodity. The download-type item is an item used for download, for example, an application. The consultation-type item is an item to be consulted, for example, a consultation product. Accordingly, the server acquires a transact control for the target item in the case that the target item is the transaction-type item; the server acquires a download control for the target item in the case that the target item is the download-type item; and the server acquires a consult control for the target item in the case that the target item is the consultation-type item. It should be understood that a virtual space for selling an item is generally provided with a transaction-type item; a virtual space for advertising an application is generally provided with a download-type item; and a virtual space for providing a consultation function is generally provided with a consultation-type item, for example, house property consultation.

In process 403, the server sends a video data stream of the virtual space to a terminal, wherein the video data stream carries the recommendation information.

The video data stream is used for recommending at least one virtual space, that is, the video data stream includes video data streams of one or more virtual spaces. In some embodiments, the video data stream is acquired by performing conversing and encoding on a known source video. For example, the video data stream of the virtual space is a data stream of a predetermined video, such as a video pre-recorded by the anchor prior to implementing this solution. In some other embodiments, the video data stream is acquired based on a source video which is acquired, converted, and encoded in real time. For example, the video data stream of the virtual space is a data stream in the live streaming data streams of the virtual space. Accordingly, a process of acquiring the video data stream by the server includes: randomly intercepting a data stream from the live streaming data streams of the virtual space, wherein the intercepted data stream is the above video data stream in process 403; or acquiring, in real time from the live streaming data streams of the virtual space, a live streaming data stream being played currently, wherein the live streaming data stream being played currently is the above video data stream in process 403. It should be noted that, the live streaming data stream is acquired based on a source video which is acquired, converted, and encoded in real time; and the source video is a video uploaded by a terminal used by the anchor.

In some embodiments, in the case that the live streaming goal is to increase the degree of interest in the anchor of the virtual space, the server adds the first recommendation information into the video data stream, so as to send the first recommendation information to the terminal, to instruct the terminal to display the follow control on the first video related to the virtual space, wherein the follow control is associated with the first recommendation information. In some other embodiments, in the case that the live streaming goal is to increase the quantity of viewers in the virtual space, the server adds the second recommendation information into the video data stream, so as to send the second recommendation information to the terminal, to instruct the terminal to display the view control for the target item in the virtual space on the first video related to the virtual space, wherein the view control for the target item is associated with the second recommendation information. In this way, for different live streaming goals, different pieces of recommendation information are sent to the terminal to trigger the terminal to display the recommendation information corresponding to the live streaming goal, such that the displayed recommendation information can better match with the live streaming goal of the virtual space. Therefore, the recommendation effect for the virtual space is improved.

In process 404, the terminal receives the video data stream for displaying a first video related to the virtual space.

In process 405, the terminal displays the first video related to the virtual space based on the video data stream.

The first video is a video displayed based on the video data stream. The solution in this embodiment of the present disclosure is subsequently described by taking that the first video related to the virtual space is displayed based on the video data stream as an example. In some other embodiments, the user may further perform an operation on the terminal to trigger the terminal to switch, based on the video data stream, to display a video corresponding to other video data, for example, to display a video related to another virtual space. In some embodiments, in response to a first slide operation on the first video, the terminal switches to display a video corresponding to last video data; or in response to a second slide operation on the first video, the terminal switches to display a video corresponding to next video data. Both the first slide operation and the second slide operation are slide operations along a predetermined direction. For example, the first slide operation may be a downward slide operation or a rightward slide operation; and the second slide operation may be an upward slide operation or a leftward slide operation.

In process 406, the terminal displays the recommendation information of the virtual space on the first video related to the virtual space.

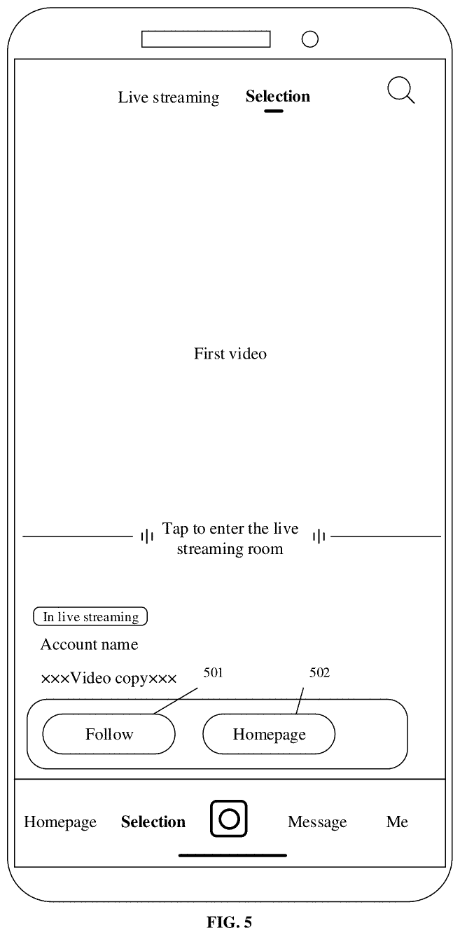

In some embodiments, a process of displaying the recommendation information of the virtual space by the terminal includes: displaying the recommendation information of the virtual space by the terminal in the form of a card on the first video related to the virtual space; or displaying the recommendation information of the virtual space by the terminal in the form of a pop-up window on the first video related to the virtual space; or displaying the recommendation information of the virtual space by the terminal in the form of a floating layer on the first video related to the virtual space. In this way, various forms for displaying the recommendation information are provided, which enriches display forms of the recommendation information, and improves display flexibility of the recommendation information. For example, FIG. 5 is a schematic diagram of a first video according to an embodiment of the present disclosure. Referring to FIG. 5, the recommendation information of the virtual space is displayed in the form of the card on the first video shown in FIG. 5.

In some embodiments, the process of displaying the recommendation information of the virtual space by the terminal includes: displaying the recommendation information of the virtual space on the first video related to the virtual space by the terminal in a display style corresponding to the live streaming goal. In this way, recommendation information corresponding to different live streaming goals is displayed in different display styles, which enriches the display styles of the recommendation information, and improves display flexibility of the recommendation information.

It should be noted that the above process 406 is described by taking that the recommendation information of the virtual space is displayed directly. In some other embodiments, the terminal displays the recommendation information of the virtual space on the first video in response to a display duration of the first video reaching a first duration. The first duration is a predetermined fixed duration, for example, 5 s. Taking that the recommendation information is to display a follow control as an example, a corresponding process includes: the terminal displays a follow control for the virtual space on the first video in response to the display duration of the first video reaching the first duration. Taking that the recommendation information is to display the view control for the target item as an example, a corresponding process includes: the terminal displays the view control for the target item in the virtual space on the first video related to the virtual space in response to the display duration of the first video reaching the first duration. In this way, in one aspect, the recommendation information is not displayed within the first duration, which avoids blocking the first video in the first duration, such that a visual field of a user can focus on the first video. In another aspect, the recommendation information of the virtual space is displayed in response to the display duration of the first video reaching the first duration, such that the displayed recommendation information is recommendation information in which the user may be interested, thereby improving a display effect of the recommendation information.

The process of displaying the recommendation information of the virtual space on the first video related to the virtual space by the terminal is described hereafter based on the two live streaming goals in process 401: to increase the degree of interest in the anchor of the virtual space and to increase the quantity of viewers in the virtual space. For the corresponding process, reference may be made to process 406A and process 406B.

In some embodiments (process 406A), in the case that the live streaming goal is to increase the degree of interest in the anchor of the virtual space, the terminal displays the follow control on the first video related to the virtual space.

The follow control is used to trigger a follow on the anchor of the virtual space. For example, referring to FIG. 5, a “Follow” control 501 is displayed in the first video shown in FIG. 5. At this time, in the case that the user wants to follow the anchor of the virtual space, the user may perform a trigger operation on the “Follow” control 501. In response to the trigger operation on the “Follow” control 501, the terminal performs a process in which the object logged in to the terminal follows the anchor of the virtual space. The trigger operation may be a tap operation.

In this embodiment, in the case that the live streaming goal is to increase the degree of interest in the anchor of the virtual space, the follow control for the anchor is displayed, such that the user can follow the anchor through just one tap operation on the follow control, which can effectively increase the degree of interest in the anchor, and improve the recommendation effect of the virtual space.

In some embodiments, the terminal further displays a homepage control on the first video related to the virtual space, wherein the homepage control is used to trigger entering an object information page of the anchor, wherein the object information page includes the follow control and information related to the anchor. The object information page is used to display object information of the anchor and a video posted by the anchor. For example, the object information page is a personal homepage of the anchor. In this case, the homepage control of the anchor is displayed, such that the user can enter the object information page of the anchor through the homepage control, and then follow the anchor through a follow control on the object information page, which can also effectively increase the degree of interest in the anchor, and improve a recommendation effect of the virtual space. It should be understood that the first recommendation information is further used to instruct to display the homepage control on the first video related to the virtual space. Accordingly, in process 402 (specifically, in process 402A), the server further needs to generate the first recommendation information for instructing to display the homepage control on the first video related to the virtual space.

For example, referring to FIG. 5, a “Homepage” control 502 is displayed in the first video shown in FIG. 5. At this time, in the case that the user wants to view the object information page of the anchor, the user may perform a trigger operation on the “Homepage” control 502. Then, the terminal displays the object information page of the anchor in response to the trigger operation on the “Homepage” control 502. Therefore, during the browsing process of the object information page, in the case that the user wants to follow the anchor of the virtual space, the user may perform a trigger operation on the “Follow” control on the object information page. Then, in response to the trigger operation on the “Follow” control, the terminal control the object logged in to the terminal to follow the anchor of the virtual space.

Further, there may further be other implementations upon the user following the anchor. For details, please refer to process A-1 or process A-2.

In some embodiments (process A-1), the terminal displays follow prompt information in response to a trigger operation on the follow control, wherein the follow prompt information is used to indicate that the anchor is followed.

In some embodiments, the terminal displays the follow prompt information on the first video in response to a trigger operation on the follow control on the first video. In some embodiments, the terminal displays the follow prompt information on the object information page in response to a trigger operation on the follow control on the object information page. For example, the follow prompt information may be “Followed”. In this case, the follow prompt information is further displayed upon the user following the anchor, such that the amount of displayed information is increased, and the user can know a follow status in time.

In some embodiments (process A-2), the terminal stops displaying the recommendation information on the first video related to the virtual space.

In some embodiments, in response to a trigger operation on the follow control on the first video, the terminal stops displaying the follow control on the first video; or in response to a trigger operation on the follow control on the first video, the terminal stops displaying the follow control and the homepage control on the first video.

In some embodiments, in the case that the object logged in to the terminal performs a trigger operation on the follow control on the object information page, the terminal stops displaying the follow control on the first video; or the terminal stops displaying the follow control and the homepage control on the first video. It should be understood that in the case that the object logged in to the terminal does not perform a trigger operation on the follow control on the object information page, in response to jumping to the first video, the terminal continues displaying the recommendation information on the first video, namely, displaying the follow control and the homepage control.

In the above embodiments, upon following the anchor, the recommendation information is stopped to display, which improves flexibility of displaying the recommendation information.

In some embodiments, in the case that the live streaming goal is to increase the degree of interest in the anchor of the virtual space, the terminal determines whether the object logged in to the terminal follows the anchor of the virtual space. In the case that the object logged in to the terminal does not follow the anchor of the virtual space, the terminal displays the follow control on the first video related to the virtual space. In the case that the object logged in to the terminal has followed the anchor of the virtual space, the terminal does not display the follow control on the first video related to the virtual space.

In some embodiments (process 406B), in the case that the live streaming goal is to increase the quantity of viewers in the virtual space, the terminal displays the view control for the target item in the virtual space on the first video related to the virtual space.

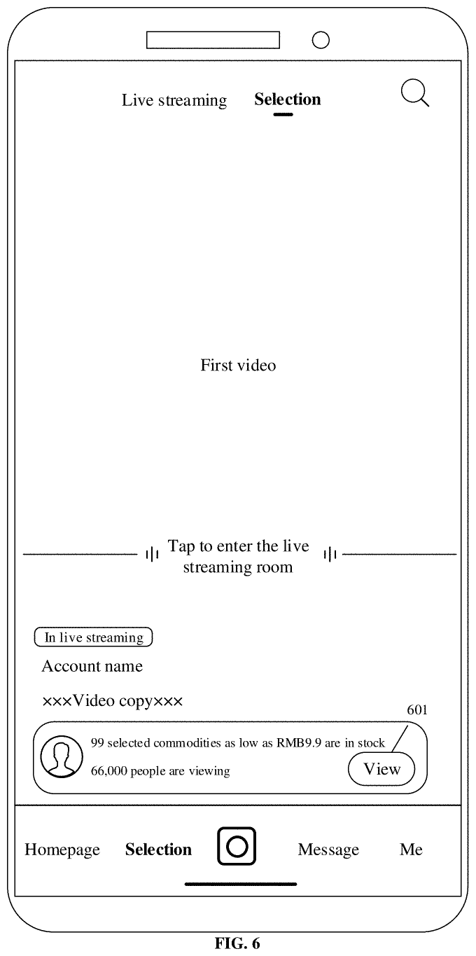

The view control is used to trigger the display of the target item in the virtual space. For example, FIG. 6 is a schematic diagram of a first video according to an embodiment of the present disclosure. Referring to FIG. 6, a “View” control 601 is displayed in the first video shown in FIG. 6. At this point, in the case that the user wants to view the target item, the user may perform a trigger operation on the “View” control 601. Then, in response to the trigger operation on the “View” control 601, the terminal jumps to the second video related to the virtual space, and displays the target item on the second video.

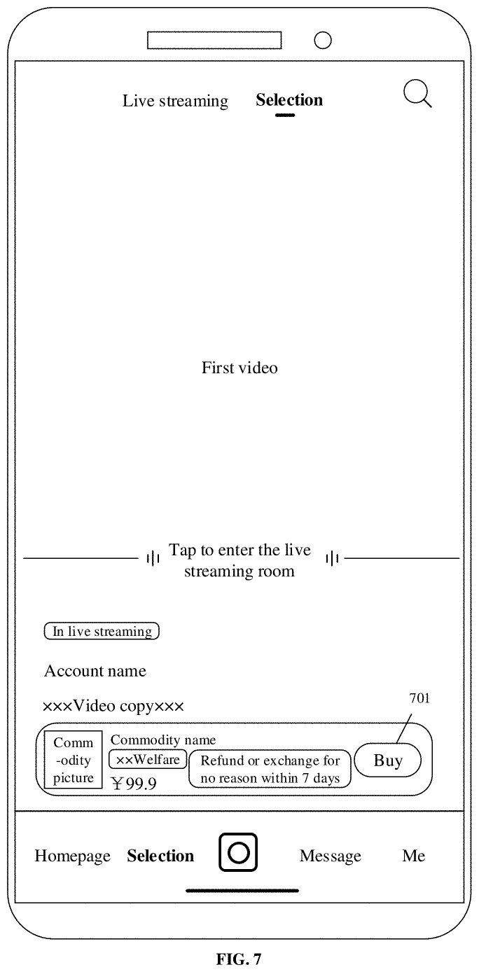

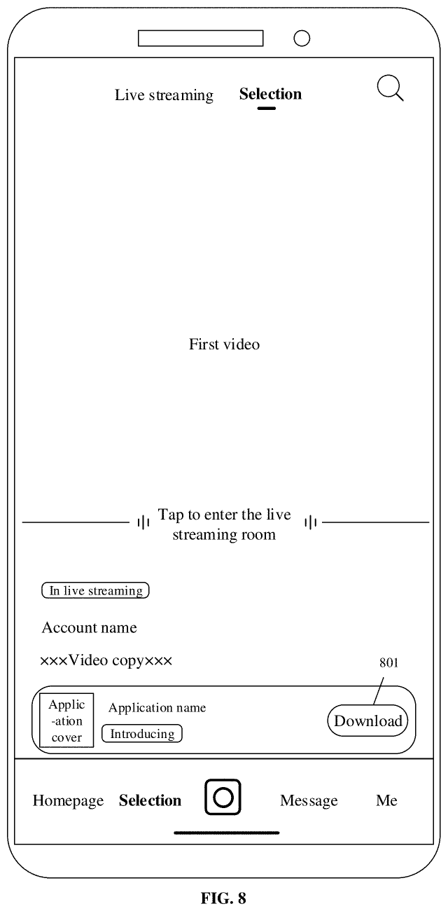

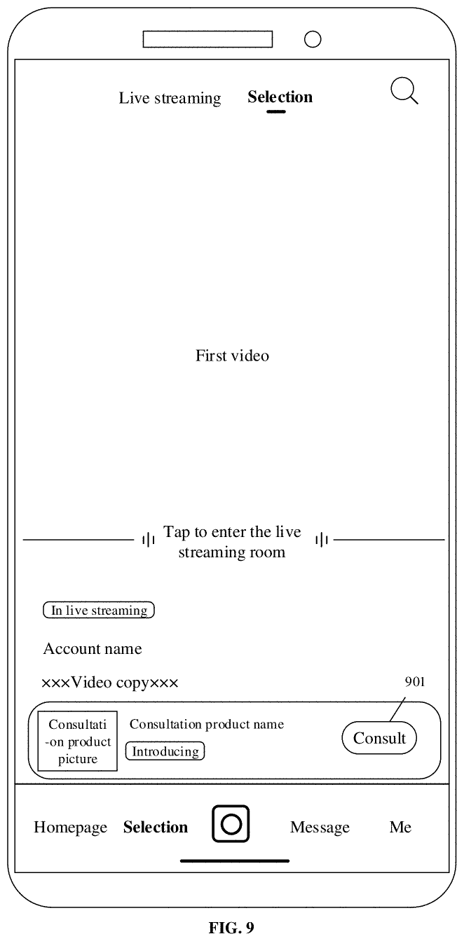

In some embodiments, the target item includes at least one of a transaction-type item, a download-type item, and a consultation-type item. Accordingly, the view control for the target item is provided as at least one of a transact control, a download control, and a consult control. For example, FIG. 7 is a schematic diagram of a first video according to an embodiment of the present disclosure. Referring to FIG. 7, in the first video shown in FIG. 7, the target item is a commodity shown in FIG. 7. The transact control may be a “Buy” control 701 shown in FIG. 7. For example, FIG. 8 is a schematic diagram of a first video according to an embodiment of the present disclosure. Referring to FIG. 8, in the first video shown in FIG. 8, the target item is an application shown in FIG. 8. The download control may be a “Download” control 801 shown in FIG. 8. For example, FIG. 9 is a schematic diagram of a first video according to an embodiment of the present disclosure. Referring to FIG. 9, in the first video shown in FIG. 9, the target item is a consultation product shown in FIG. 9. The consult control may be a “Consult” control 901 shown in FIG. 9.

In some embodiments, the terminal further displays item information of the target item on the first video related to the virtual space, wherein the item information includes at least one of an item picture, an item name, an item tag, an item state, and an item transaction resource.

The item tag indicates a virtual resource associated with the target item. The virtual resource is a virtual coupon for the target item, for example, “An RMB10 discount for every RMB100”; or the virtual resource is a transaction right and interests possessed by a user when transaction the target item, for example, “Refund or exchange for no reason within 7 days”. The item state indicates a state of the target item in the virtual space. The item state is an introduction state of the target item in the virtual space, for example, “Introducing”; or the item state is an activity state of the target item in the virtual space, for example, “Bargains for seconds,” “Hot selling,” or “XX welfare”. The item transaction resource indicates a transaction resource required for acquiring the target item, namely, an item price. In this way, the item information of the target item is displayed, such that the amount of information displayed on the first video is increased. It should be understood that the second recommendation information is further used to instruct to display the item information of the target item on the first video related to the virtual space. Accordingly, in process 402 (specifically, in 402A), the server is also required to generate the second recommendation information used to instruct to display the item information of the target item on the first video related to the virtual space.

For example, referring to FIG. 7, in the first video shown in FIG. 7, the target item is a commodity shown in FIG. 7. Accordingly, the item information of the target item is commodity information shown in FIG. 7. For example, the item picture may be “Commodity picture” shown in FIG. 7; the item name may be “Commodity name” shown in FIG. 7; the item tag may be “Refund or exchange for no reason within 7 days” as shown in FIG. 7; the item state may be “XX welfare” shown in FIG. 7; and the item transaction resource may be the commodity price “RMB99.9” shown in FIG. 7.

For example, referring to FIG. 8, in the first video shown in FIG. 8, the target item is an application shown in FIG. 8. Accordingly, the item information of the target item is the application information shown in FIG. 8. For example, the item picture may be the “Application cover” shown in FIG. 8; the item name may be the “Application name” shown in FIG. 8; and the item state may be “Introducing” shown in FIG. 8. It should be noted that FIG. 8 is shown by using “Application cover,” “Application name,” and “Introducing” as examples. In some other embodiments, an application tag (namely, the item tag) and an application download fee (namely, the item transaction resource) of the application may also be displayed.

For example, referring to FIG. 9, in the first video shown in FIG. 9, the target item is a consultation product shown in FIG. 9. Accordingly, the item information of the target item is consultation product information shown in FIG. 9. For example, the item picture may be the “Consultation product picture” shown in FIG. 9; the item name may be the “Consultation product name” shown in FIG. 9; and the item state may be “Introducing” shown in FIG. 9. It should be noted that FIG. 9 is shown by using “Consultation product picture,” “Consultation product name,” and “Introducing” as examples. In some other embodiments, a product tag (namely, the item tag) and a product consultation fee (namely, the item transaction resource) of the consultation product may also be displayed.

In some embodiments, when displaying the item information of the target item, the terminal displays the first item information in the form of a main title, and displays the second item information in the form of a subtitle. The first item information is one or more pieces of the above item information; and the second item information is one or more of the other pieces of the above item information. For example, taking that the first item information is the item name, and the second item information is the item tag as an example, a corresponding process includes: the terminal displays the item name in the form of the main title, and displays the item tag in the form of the subtitle. In this way, an effect of displaying the item information of the target items is improved. For example, referring to FIG. 7, in the first video shown in FIG. 7, the “Commodity name” is displayed in the form of the main title, and “Refund or exchange for no reason within 7 days” and “XX welfare” are displayed in the form of the subtitle. For example, referring to FIG. 8, in the first video shown in FIG. 8, the “Application name” is displayed in the form of the main title, and “Introducing” is displayed in the form of the subtitle. For example, referring to FIG. 9, in the first video shown in FIG. 9, the “Consultation product name” is displayed in the form of the main title, and the “Introducing” is displayed in the form of the subtitle.

Further, there may further be the following implementations based on the view control displayed on the first video. For details, please refer to process B-1 and process B-2.

In some embodiments (process B-1), in response to a trigger operation on the view control for the target item, the terminal displays the target item on an item list page provided by the virtual space, wherein the item list page is used to display at least one item.

In some embodiments, the process B-1 is performed jointly by the terminal and the server. A corresponding process includes: the terminal sends a first object display request to the server in response to the trigger operation on the view control for the target item; and the server sends the live streaming data stream of the virtual space and the item list page provided by the virtual space to the terminal in response to the first object display request, to trigger the terminal to display the target item on the item list page provided by the virtual space. In this way, the server sends the live streaming data stream and the item list page of the virtual space to the terminal, such that the terminal displays, based on the live streaming data stream, the second video related to the virtual space and the item list page, which ensures that the second video and the item list page can be displayed successfully. The trigger operation on the view control for the target item is a tap operation on the view control for the target item.

In some embodiments, in response to the trigger operation on the view control for the target item, the terminal prominently displays an item where the target item is located on the item list page provided by the virtual space. For example, the item where the target item is located is displayed in a highlighted form or a shaking form.

In the above embodiments, by triggering the view control for the target item, an effect of jumping to the virtual space through one tap can be achieved, and the target item can be displayed on the item list page of the virtual space. Therefore, the positioning of the target item in the virtual space is achieved, and human-computer interaction efficiency is improved.

For the above three types of the target items described above, there are different processes of displaying the target items on the item list page of the virtual space. The corresponding process includes any one of the followings.

In some embodiments, in response to a trigger operation on the transact control for the target item, the terminal displays the target item on the item list page provided by the virtual space. For example, taking that the item is a commodity as an example, in response to a trigger operation on a transact control for a target commodity, the terminal displays the target commodity on a commodity list page provided by the virtual space.

In some other embodiments, in response to a trigger operation on the download control for the target item, the terminal displays the target item on the item list page provided by the virtual space. For example, taking that the item is an application as an example, in response to a trigger operation on a download control for a target application, the terminal displays the target application on an application list page provided by the virtual space.

In some other embodiments, in response to a trigger operation on the consult control for the target item, the terminal displays the target item on the item list page provided by the virtual space. For example, taking that the item is a consultation product as an example, in response to a trigger operation on a consult control for a target consultation product, the terminal displays the target consultation product on a product list page provided by the virtual space.

It should be noted that the embodiment corresponding to process B-1 is described by taking that the target item is triggered to display through the view control for the target item. In some other embodiments, a corresponding information page may be triggered to display based on a region of the recommendation information. Accordingly, process B-1 may be replaced by the following: in response to a trigger operation on the region of the recommendation information, the terminal displays the target item on the item list page provided by the virtual space. In some embodiments, taking that the recommendation information of the virtual space is displayed in the form of a card as an example, the above process may be replaced by the following: in response to a trigger operation on a region of the card, the terminal displays the target item on the item list page provided by the virtual space.

In some other embodiments (process B-2), the terminal displays an associated page of the target item in the virtual space in response to the trigger operation on the view control for the target item.

In some embodiments, the process B-2 is performed jointly by the terminal and the server. A corresponding process includes: the terminal sends a second object display request to the server in response to the trigger operation on the view control for the target item; and the server sends the live streaming data stream of the virtual space and the associated page of the target item to the terminal in response to the second object display request from the terminal, to trigger the terminal to display the associated page of the target item in the virtual space. In this way, the server sends the live streaming data stream of the virtual space and the corresponding associated page to the terminal, such that the terminal displays, based on the live streaming data stream, the second video related to the virtual space and the associated page, which ensures that the second video and the associated page can be displayed successfully.

In the above embodiments, by triggering the view control for the target item, the effect of jumping to the virtual space with one tap can be achieved, and the associated page of the target item can be displayed in the virtual space. Therefore, the positioning of the target item in the virtual space is achieved, and human-computer interaction efficiency is improved.

For the above three types of target items described above, associated pages of the target items displayed in the virtual space are different. A corresponding process includes any one of the followings.

In some embodiments, the terminal displays an item transaction page for the target item in the virtual space in response to a trigger operation on the transact control for the target item, wherein the item transaction page is used for transacting the target item. For example, the item transaction page is a commodity ordering page or a commodity payment page. In some embodiments, the terminal displays the item transaction page in the form of a floating layer or a pop-up window in the virtual space.

In some embodiments, the terminal displays an item download page for the target item in the virtual space in response to a trigger operation on the download control for the target item, wherein the item download page is used for downloading the target item. For example, the item download page is provided as an application download page. In some embodiments, the terminal displays the item download page in the form of a floating layer or a pop-up window in the virtual space, for example, a download floating layer or a download pop-up window.

In some embodiments, the terminal displays an information acquisition page for the target item in the virtual space in response to a trigger operation on the consult control for the target item, wherein the information acquisition page is used for acquiring information required for consulting about the target item. In some embodiments, the terminal displays the information acquisition page in the form of a floating layer or a pop-up window in the virtual space, for example, a clue acquisition pop-up window.

In the above embodiments, different types of view controls can be displayed for target items of different types, and different types of associated pages of target items can be triggered to display through view controls of corresponding types, which enriches the display styles of the associated pages and improves flexibility of displaying the associated pages.

It should be noted that the embodiment corresponding to process B-2 is described by taking that the associated page is triggered to display through the view control for the target item. In some other embodiments, the associated page may be triggered to display based on the region of the recommendation information. Accordingly, process B-2 may be replaced by the following: the terminal displays the associated page of the target item in the virtual space in response to a trigger operation on the region of the recommendation information. In some embodiments, taking that the recommendation information of the virtual space is displayed in the form of a card as an example, the above process may be replaced by the following: the terminal displays the associated page of the target item in the virtual space in response to a trigger operation on a region of the card.

In the above embodiments, in the case that the live streaming goal is to increase the quantity of viewers in the virtual space, the view control for the target item is displayed, such that a user can be attracted to enter the virtual space through the view control to view the target item, which can effectively increase the quantity of viewers in the virtual space, and improve an effect of recommending the virtual space.

It should be noted that the embodiment corresponding to process 406B is described by taking that the user triggers the view control as an example. In some other embodiments, the display of the view control is stopped in the case that no trigger operation for the view control is detected within a second duration. The second duration is a predetermined fixed duration, for example, 10 s. For example, the display of the view control is stopped in the case that no trigger operation for the view control is detected within 10 s. In this way, the display of the recommendation information is stopped in the case that no trigger operation for the view control is detected within a long duration, which improves flexibility of displaying the recommendation information.

In some embodiments, in addition to the above recommendation information shown in process 406A and process 406B, the recommendation information of the virtual space further includes at least one piece of associated information of the virtual space. Accordingly, the terminal may further display at least one piece of associated information of the virtual space. A corresponding process includes at least one of the followings.

(1) In some embodiments, the terminal displays an object picture of the anchor of the virtual space on the first video related to the virtual space.

In some embodiments, the object picture of the anchor is a fixed picture predetermined by the anchor; or the object picture of the anchor is a profile picture of the anchor, for example, a profile picture of an anchor account; or the object picture of the anchor is a picture taken from the second video (i.e., the live streaming video) of the virtual space, for example, a character picture taken from the live streaming video or an item picture taken from the live streaming video.

(2) In some embodiments, the terminal displays item prompt information on the first video related to the virtual space, wherein the item prompt information indicates an entry into the virtual space to view at least one item provided in the virtual space.

For example, the content of the item prompt information may be “Enter the live streaming room to get more surprises.”

(3) In some embodiments, the terminal displays activity prompt information on the first video related to the virtual space, wherein the activity prompt information indicates presence of at least one item in the virtual space participating in a target activity.

The target activity is a predetermined fixed activity, for example, a specifical offer or a welfare activity. For example, the content of the activity prompt information may be “Welfare for commodity XXX being Handing out.”

(4) In some embodiments, the terminal displays resource prompt information on the first video related to the virtual space, wherein the resource prompt information indicates an item transaction resource meeting a resource quantity condition in item transaction resources of at least one item in the virtual space.

In some embodiments, the resource quantity condition is that a quantity of the item transaction resource is less than or equal to a transaction resource threshold; or the resource quantity condition is that the quantity of the item transaction resource is minimum. For example, the content of the resource prompt information may be “Commodity XXX is as low as XX”.

In some embodiments, the above at least one item in embodiments (2) to (4) is at least one item that has been posted (or referred to as in stock) in the virtual space. In some other embodiments, the above at least one item in embodiments (2) to (4) is at least one item that has not been posted (or referred to as not in stock) in the virtual space.

(5) In some embodiments, the terminal displays first quantity prompt information on the first video related to the virtual space, wherein the first quantity prompt information indicates a quantity of at least one item posted in the virtual space.

For example, the content of the first quantity prompt information may be “99 selected commodities are in stock.”

(6) In some embodiments, the terminal displays second quantity prompt information on the first video related to the virtual space, wherein the second quantity prompt information indicates a quantity of online viewers in the virtual space.

In some embodiments, the terminal displays the second quantity prompt information on the first video related to the virtual space in response to the quantity of online viewers in the virtual space reaching a target quantity. In this way, the second quantity prompt information is displayed in response to the quantity of online viewers reaching a target quantity, thereby improving a display effect of the second quantity prompt information. The target quantity is a predetermined fixed quantity, for example, 10,000.

For example, the content of the second quantity prompt information may be “66,000 people are viewing.”

(7) In some embodiments, the terminal displays third quantity prompt information on the first video related to the virtual space, wherein the third quantity prompt information indicates a quantity of viewers having reserved an item in the virtual space.

For example, the content of the third quantity prompt information may be “100 people have reserved for purchase”.

In the above embodiments, the object picture of the anchor or various types of prompt information are displayed, such that the amount of information displayed on the first video is increased.

It should be noted that the terminal may display information by using one or more of (1) to (7). For example, referring to FIG. 6, the object picture of the anchor of the virtual space, the resource prompt information, the first quantity prompt information, and the second quantity prompt information are displayed in the first video shown in FIG. 6.

In some embodiments, for displaying at least one piece of associated information of the virtual space, the terminal displays the first associated information in the form of a main title, and displays the second associated information in the form of a subtitle. The first associated information is one or more items of the above prompt information in (2) to (7), and the second associated information is one or more of the other items of the above prompt information in (2) to (7). For example, the first associated information is the first quantity prompt information, and the second associated information is the second quantity prompt information. A corresponding process includes: displaying the first quantity prompt information in the form of the main title and displaying the second quantity prompt information in the form of the subtitle. In this way, a display effect of the associated information is improved. For example, referring to FIG. 6, in the first video shown in FIG. 6, “99 selected commodities as low as RMB9.9 are in stock” is displayed in the form of the main title, and “66,000 people are viewing” is displayed in the form of the subtitle.

It should be understood that for the above associated information in (1) to (7), in process 402, the server needs to acquire associated information of the virtual space. In some embodiments, the server is provided with a text template. Upon acquiring the corresponding associated information, the above prompt information may be acquired by adding the corresponding associated information into the text template. For example, upon acquiring the quantity of the online viewers in the virtual space, the terminal may acquire the second quantity prompt information of the target item by adding the quantity of online viewers in the virtual space into the text template.

In some embodiments, the text template is provided with a first title field and a second title field. The terminal adds the above first associated information into the first title field, and adds the above second associated information into the second title field. The first title field may be a main title field for adding text information of a main title type, and the second title field may be a subtitle field for adding text information of a subtitle type. Taking the above (5) and (6) as examples, the terminal adds a quantity of at least one item posted in the virtual space into the main title field, and adds the quantity of online viewers in the virtual space into the subtitle field. Therefore, for displaying the recommendation information of the virtual space, the terminal displays the quantity of at least one item posted in the virtual space in a region of the main title and displays the quantity of online viewers in the virtual space in a region of the subtitle.

In some embodiments, display priorities may further be specified for the above associated information in (1) to (7), such that associated information having a high display priority is displayed preferentially based on the display priorities of various pieces of associated information.

It should be also noted that, in the embodiment corresponding to process 406B, the terminal may also display at least one piece of the above associated information in (1) to (7) prior to displaying the view control for the target item. In some embodiments, the terminal displays at least one piece of the associated information of the virtual space on the first video related to the virtual space; and switches to display the view control for the target item in response to a display duration of the at least one piece of associated information reaching a third duration. For example, referring to FIG. 6 to FIG. 7, the terminal may display the recommendation information shown in FIG. 6 prior to displaying the recommendation information shown in FIG. 7. In some embodiments, in response to the display duration of the at least one piece of associated information reaching the third duration, the terminal moves the at least one piece of associated information out of the first video through a first animated special effect and moves the view control for the target item into the first video through a second animated special effect. For example, the first animated special effect may be sliding out from a left side or an upper side; the second animated special effect may be sliding in from a right side or a lower side.

In the above process 406, different pieces of recommendation information are displayed to users based on two different live streaming goals, such that subsequent processes can be performed based on a follow control or a view control in the recommendation information. In some embodiments, upon displaying the recommendation information of the virtual space, the terminal displays a second video related to the virtual space in response to a trigger operation on any region in the first video other than a region of the recommendation information, wherein the second video is acquired based on a live streaming data stream of the virtual space. In this way, through the trigger operation on the first video, an effect of jumping to the live streaming video related to the virtual space by one tap can be achieved, thereby improving the human-computer interaction efficiency. In some embodiments, this process is performed jointly by the terminal and the server. A corresponding process includes: the terminal sends an image display request to the server in response to a trigger operation on any region in the first video other than the region of the recommendation information; the server sends a live streaming data stream of the virtual space to the terminal in response to the image display request from the terminal, to trigger the terminal to display a second video related to the virtual space, In this way, the server sends the live streaming data stream of the virtual space to the terminal, such that the terminal displays the second video related to the virtual space based on the live streaming data stream, which ensures that the second video can be displayed successfully.

In the technical solutions according to this embodiment of the present disclosure, in the case that video data streams of a virtual space are recommended to a user, recommendation information corresponding to a live streaming goal of the virtual space is displayed for the user based on the live streaming goal. Therefore, a recommending method for the virtual space based on the live streaming goal is provided. Different pieces of recommendation information can be displayed for the user based on different live streaming goals. Thus, the amount of displayed information is increased, and the displayed recommendation information can better match with the live streaming goal of the virtual space. Therefore, the recommendation effect for the virtual space is improved.

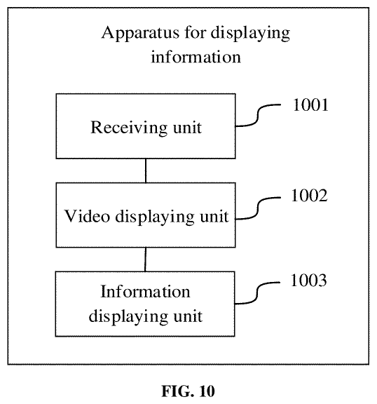

FIG. 10 is a block diagram of an apparatus for displaying information according to an embodiment of the present disclosure. Referring to FIG. 10, the apparatus includes a receiving unit 1001, a video displaying unit 1002, and an information displaying unit 1003.

The receiving unit 1001 is configured to receive a video data stream for displaying a first video related to a virtual space and recommending the virtual space.

The video displaying unit 1002 is configured to display the first video related to the virtual space based on the video data stream.

The information displaying unit 1003 is configured to display recommendation information of the virtual space on the first video related to the virtual space, wherein the recommendation information is determined based on a live streaming goal of the virtual space, the live streaming goal indicating an effect to be achieved by live streaming.

In the technical solutions according to this embodiment of the present disclosure, in the case that video data streams of a virtual space are recommended to a user, recommendation information corresponding to a live streaming goal of the virtual space is displayed for the user based on the live streaming goal. Therefore, a recommending method for the virtual space based on the live streaming goal is provided. Different pieces of recommendation information can be displayed for the user based on different live streaming goals. Thus, the amount of displayed information is increased, and the displayed recommendation information can better match with the live streaming goal of the virtual space. Therefore, the recommendation effect for the virtual space is improved.

In some embodiments, the information displaying unit 1003 is configured to:

display the recommendation information of the virtual space on the first video related to the virtual space in a display style corresponding to the live streaming goal.

In some embodiments, the information displaying unit 1003 is configured to:

display the recommendation information of the virtual space on the first video in response to a display duration of the first video reaching a first duration.

In some embodiments, the video displaying unit 1002 is further configured to:

display a second video related to the virtual space in response to a trigger operation on any region in the first video other than a region of the recommendation information, wherein the second video is acquired based on a live streaming data stream of the virtual space.

In some embodiments, the information displaying unit 1003 includes:

a first displaying sub-unit, configured to display a follow control on the first video related to the virtual space in the case that the live streaming goal is to increase a degree of interest in an anchor of the virtual space, wherein the follow control is used to trigger a follow on the anchor of the virtual space; or

a second displaying sub-unit, configured to display a view control for a target item in the virtual space on the first video related to the virtual space in the case that the live streaming goal is to increase a quantity of viewers in the virtual space, wherein the view control is used to trigger display of the target item in the virtual space, and the target item is an item to be recommended.

In some embodiments, the first displaying sub-unit is further configured to:

display a homepage control on the first video related to the virtual space, wherein the homepage control is used to trigger a visit of an object information page of the anchor, the object information page including the follow control.

In some embodiments, the first displaying sub-unit is further configured to:

display follow prompt information in response to a trigger operation on the follow control, wherein the follow prompt information is used to prompt that the anchor is followed.

In some embodiments, the first displaying sub-unit is further configured to:

stop displaying the recommendation information on the first video related to the virtual space.

In some embodiments, the second displaying sub-unit is further configured to:

display item information of the target item on the first video related to the virtual space, wherein the item information includes at least one of an item picture, an item name, an item tag, an item state, and an item transaction resource, the item tag indicating a virtual resource associated with the target item, the item state indicating a state of the target item in the virtual space, and the item transaction resource indicating a transaction resource required for acquiring the target item.

In some embodiments, the second displaying sub-unit further includes:

a first page displaying sub-unit, configured to: in response to a trigger operation on the view control for the target item, display the target item on an item list page provided by the virtual space, wherein the item list page is used to display at least one item; or

a second page displaying sub-unit, configured to display an associated page of the target item in the virtual space in response to the trigger operation on the view control for the target item.

In some embodiments, the target item includes at least one of a transaction-type item, a download-type item, and a consultation-type item. Accordingly, the view control for the target item includes at least one of a transact control, a download control, and a consult control; and

the second page displaying sub-unit is configured to:

display an item transaction page for the target item in the virtual space in response to a trigger operation on the transact control for the target item, wherein the item transaction page is used for transacting the target item; or

display an item download page for the target item in the virtual space in response to a trigger operation on the download control for the target item, wherein the item download page is used for downloading the target item; or

display an information acquisition page for the target item in the virtual space in response to a trigger operation on the consult control for the target item, wherein the information acquisition page is used for acquiring information required for consulting about the target item.

In some embodiments, the second displaying sub-unit is further configured to:

stop displaying the view control in the case that no trigger operation for the view control is detected within a second duration.

In some embodiments, the target item includes at least one of an item matching with an object logged in to the terminal, an item being introduced in the virtual space, and an item meeting a target condition in the virtual space, which belongs to at least one items provided in the virtual space.

In some embodiments, the recommendation information further includes at least one piece of associated information of the virtual space; and

the information displaying unit 1003 is further configured to:

display an object picture of the anchor of the virtual space on the first video related to the virtual space;

display item prompt information on the first video related to the virtual space, wherein the item prompt information indicates an entry into the virtual space to view at least one item provided in the virtual space;

display activity prompt information on the first video related to the virtual space, wherein the activity prompt information indicates presence of at least one item in the virtual space participating in a target activity;

display resource prompt information on the first video related to the virtual space, wherein the resource prompt information indicates an item transaction resource meeting a resource quantity condition in item transaction resources of at least one item in the virtual space;

display first quantity prompt information on the first video related to the virtual space, wherein the first quantity prompt information indicates a quantity of at least one item posted in the virtual space;

display second quantity prompt information on the first video related to the virtual space, wherein the second quantity prompt information indicates a quantity of online viewers in the virtual space; or

display third quantity prompt information on the first video related to the virtual space, wherein the third quantity prompt information indicates a quantity of viewers having reserved an item in the virtual space.

In some embodiments, the information displaying unit 1003 is further configured to:

display the second quantity prompt information on the first video related to the virtual space in response to the quantity of online viewers in the virtual space reaching a target quantity.

In some embodiments, in the case that the live streaming goal is to increase the quantity of viewers in the virtual space, the second displaying sub-unit is further configured to:

display at least one piece of associated information of the virtual space on the first video related to the virtual space; and

switch to display the view control for the target item in response to a display duration of the at least one piece of associated information reaching a third duration.

In some embodiments, the information displaying unit 1003 is configured to:

display the recommendation information of the virtual space in the form of a card on the first video related to the virtual space;

display the recommendation information of the virtual space in the form of a pop-up window on the first video related to the virtual space; or

display the recommendation information of the virtual space in the form of a floating layer on the first video related to the virtual space.

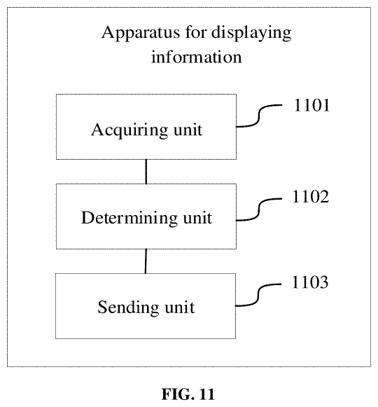

FIG. 11 is a block diagram of an apparatus for displaying information according to an embodiment of the present disclosure. Referring to FIG. 11, the apparatus includes an acquiring unit 1101, a determining unit 1102, and a sending unit 1103.

The acquiring unit 1101 is configured to acquire a live streaming goal of a virtual space, wherein the live streaming goal indicates an effect to be achieved by live streaming.

The determining unit 1102 is configured to determine recommendation information of the virtual space based on the live streaming goal of the virtual space.

The sending unit 1103 is configured to send a video data stream of the virtual space to a terminal, wherein the video data stream carries the recommendation information, to trigger the terminal, based on the video data stream, to display a first video related to the virtual space and display the recommendation information of the virtual space on the first video related to the virtual space, wherein the video data stream is used for recommending the virtual space.

In the technical solutions according to this embodiment of the present disclosure, in the case that video data streams of a virtual space are recommended to a user, recommendation information corresponding to a live streaming goal of the virtual space is displayed for the user based on the live streaming goal. Therefore, a recommendation method for the virtual space based on the live streaming goal is provided. Different pieces of recommendation information can be displayed for the user based on different live streaming goals. Thus, the amount of displayed information is increased, and the displayed recommendation information can better match with the live streaming goal of the virtual space. Therefore, the recommendation effect for the virtual space is improved.

In some embodiments, the acquiring unit 1101 is configured to:

acquire, based on a space identifier of the virtual space, a live streaming goal corresponding to the space identifier from first relationship data, and determine the acquired live streaming goal as the live streaming goal of the virtual space, wherein the first relationship data indicates a corresponding relationship between the space identifier and the live streaming goal; or

acquire the live streaming goal of the virtual space by performing image recognition on a second video related to the virtual space, wherein the second video is acquired based on a live streaming data stream of the virtual space.

In some embodiments, the determining unit 1102 is configured to:

acquire, based on the live streaming goal of the virtual space, an information type corresponding to the live streaming goal from second relationship data, wherein the information type indicates a type of recommendation information to be determined, and the second relationship data indicates a corresponding relationship between the live streaming goal and the information type; and

acquire recommendation information of the acquired information type of the virtual space.

In some embodiments, the sending unit 1103 is further configured to:

send a live streaming data stream of the virtual space to the terminal in response to an image display request from the terminal, to trigger the terminal to display a second video related to the virtual space, wherein the image display request is sent in response to a trigger operation on any region in the first video other than a region of the recommendation information.

In some embodiments, the sending unit 1103 further includes:

a first sending sub-unit, configured to send first recommendation information to the terminal in the case that the live streaming goal is to increase a degree of interest in an anchor of the virtual space, wherein the first recommendation information is to display a follow control on the first video related to the virtual space, the follow control being used to trigger a follow on the anchor of the virtual space; or

a second sending sub-unit, configured to send second recommendation information to the terminal in the case that the live streaming goal is to increase a quantity of viewers in the virtual space, wherein the second recommendation information is to display a view control for a target item in the virtual space on the first video related to the virtual space, the view control is used to trigger display of the target item in the virtual space, and the target item is an item to be recommended.

In some embodiments, the acquiring unit 1101 is further configured to:

acquire, from at least one item provided in the virtual space, at least one of an item matching with an object logged in to the terminal, an item being introduced in the virtual space, and an item meeting a target condition in the virtual space; and determine the acquired item as the target item.

In some embodiments, the second sending sub-unit is further configured to:

send a live streaming data stream of the virtual space and an item list page provided by the virtual space to the terminal in response to a first object display request from the terminal, to trigger the terminal to display the target item on the item list page provided by the virtual space, wherein the item list page is used to display at least one item, and the first object display request is sent in response to a trigger operation on the view control for the target item; or

send the live streaming data stream of the virtual space and an associated page of the target item to the terminal in response to a second object display request from the terminal, to trigger the terminal to display the associated page of the target item in the virtual space, wherein the second object display request is sent in response to a trigger operation on the view control for the target item.

It should be noted that the apparatus for displaying information according to the foregoing embodiments, when displaying information, is illustrated only by taking the dividing form of the above functional modules as an example. In practice, the above functions may be allocated to and completed by different functional modules as required, that is, an internal structure of the apparatus may be divided into different functional modules to complete all or some of the functions described above. In addition, the apparatus for displaying information according to the above embodiment is based on the same concept as the embodiments of the method for displaying information. For details about the implementation process of the apparatus, please refer to the method embodiments. Details are not repeated herein again.

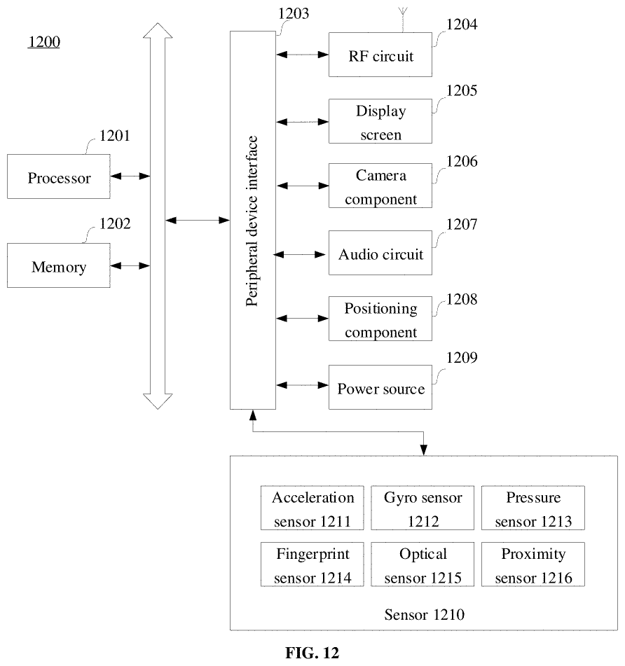

The computer device in the embodiments of the present disclosure may be a terminal. FIG. 12 is a structural block diagram of a terminal 1200 according to an exemplary embodiment of the present disclosure. Typically, the terminal 1200 includes one or more processors 1201 and a memory 1202.

The processor 1201 may include one or more processing cores. For example, the processor 1201 may be a 4-core processor or an 8-core processor. The processor 1201 may be implemented by at least one hardware of a digital signal processor (DSP), a field-programmable gate array (FPGA), and a programmable logic array (PLA). In some embodiments, the processor 1201 may be integrated with a graphics processing unit (GPU), which is configured to render and draw the content that needs to be displayed by a display screen. In some embodiments, the processor 1201 may further include an artificial intelligence (AI) processor configured to process computational operations related to machine learning.

The memory 1202 may include one or more computer-readable storage mediums, which may be non-transitory. The memory 1202 may further include a high-speed random access memory, as well as a non-volatile memory, such as one or more disk storage devices and flash storage devices. In some embodiments, the non-transitory computer-readable storage medium in the memory 1202 is configured to store one or more program codes. The one or more program codes, when loaded and executed by the processor 1201 of an electronic device, cause the device to perform the method for displaying information as defined in the method embodiments of the present disclosure.

In some embodiments, the terminal 1200 may further include a peripheral device interface 1203 and at least one peripheral device. The processor 1201, the memory 1202, and the peripheral device interface 1203 may be connected via a bus or a signal line. Each peripheral device may be connected to the peripheral device interface 1203 via a bus, a signal line, or a circuit board. Specifically, the peripheral device includes at least one of a radio frequency circuit 1204, a display screen 1205, a camera component 1206, an audio circuit 1207, a positioning component 1208, and a power source 1209.

The peripheral device interface 1203 may be configured to connect at least one peripheral device associated with an input/output (I/O) to the processor 1201 and the memory 1202. In some embodiments, the processor 1201, the memory 1202, and the peripheral device interface 1203 are integrated on the same chip or circuit board. In some other embodiments, any one or two of the processor 1201, the memory 1202, and the peripheral device interface 1203 are implemented on a separate chip or circuit board, which is not limited in this embodiment of the present disclosure.

The radio frequency (RF) circuit 1204 is configured to receive and transmit a radio frequency signal, which is also referred to as an electromagnetic signal. The radio frequency circuit 1204 communicates with a communication network and other communication devices via the electromagnetic signal. The radio frequency circuit 1204 converts an electrical signal into an electromagnetic signal for transmission, or converts a received electromagnetic signal into an electrical signal.

The display screen 1205 is configured to display a user interface (UI). The UI may include graphics, text, icons, videos, and any combination thereof. In the case that the display screen 1205 is a touch display screen, the display screen 1205 can further acquire a touch signal on or over the surface of the display screen 1205. The touch signal may be input into the processor 1201 as a control signal for processing. In this case, the display screen 1205 may be further configured to provide virtual buttons and/or a virtual keyboard, which are also referred to as soft buttons and/or a soft keyboard.

The camera component 1206 is configured to capture images or videos. In some embodiments, the camera component 1206 includes a front camera and a rear camera.

The audio circuit 1207 may include a microphone and a speaker. The microphone is configured to: acquire a sound wave of a user and an environment, and convert the sound wave into an electrical signal which is input into the processor 1201 for processing, or input into the RF circuit 1204 for voice communication.

The positioning component 1208 is configured to position the current geographic location of the terminal 1200 to implement navigation or location based service (LBS). The positioning component 1208 may be the United States' Global Positioning System (GPS), China's BeiDou Navigation Satellite System (BDS), Russia's Global Navigation Satellite System (GLONASS), or the European Union's Galileo Satellite Navigation System (Galileo).

The power source 1209 is configured to power up various components in the terminal 1200. The power source 1209 may be alternating current, direct current, a disposable battery, or a rechargeable battery. In the case that the power source 1209 includes the rechargeable battery, the rechargeable battery may support wired or wireless charging. The rechargeable battery may also support the fast charging technology.

In some embodiments, the terminal 1200 further includes one or more sensors 1210. The one or more sensors 1210 include, but are not limited to, an acceleration sensor 1211, a gyro sensor 1212, a pressure sensor 1213, a fingerprint sensor 1214, an optical sensor 1215, and a proximity sensor 1216.

The acceleration sensor 1211 may detect magnitudes of accelerations on three coordinate axes of a coordinate system established by the terminal 1200. For example, the acceleration sensor 1211 may be configured to detect components of a gravitational acceleration on the three coordinate axes.

The gyro sensor 1212 may detect a body direction and a rotation angle of the terminal 1200, and cooperate with the acceleration sensor 1211 to collect a 3D motion of the user on the terminal 1200.

The pressure sensor 1213 may be disposed on a side frame of the terminal 1200 and/or a lower layer of the display screen 1205. In the case that the pressure sensor 1213 is disposed on the side frame of the terminal 1200, a user's holding signal to the terminal 1200 can be detected. The processor 1201 can perform left-right hand recognition or quick operation according to the holding signal acquired by the pressure sensor 1213.

The fingerprint sensor 1214 is configured to acquire a user's fingerprint. The processor 1201 identifies the user's identity based on the fingerprint acquired by the fingerprint sensor 1214, or the fingerprint sensor 1214 identifies the user's identity based on the acquired fingerprint.

The optical sensor 1215 is configured to acquire ambient light intensity. In an embodiment, the processor 1201 may control the display brightness of the display screen 1205 according to the ambient light intensity acquired by the optical sensor 1215.

The proximity sensor 1216, also referred to as a distance sensor, is usually disposed on the front panel of the terminal 1200. The proximity sensor 1216 is configured to acquire a distance between the user and the front surface of the terminal 1200.

The terminal 1200 is configured to perform the process applicable to the terminal in the method for displaying information provided in the method embodiments.

A person skilled in the art may understand that the structure shown in FIG. 12 does not constitute a limitation to the terminal 1200. The terminal 1200 may include more or fewer components than those shown in the figure, or combine some components, or adopt different component arrangements.

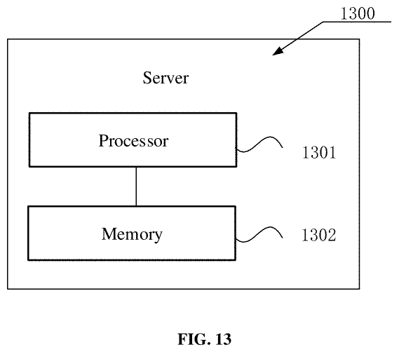

The computer device in the embodiments of the present disclosure may be a server. FIG. 13 is a block diagram of a server according to an embodiment of the present disclosure. The server 1300 may vary greatly depending on different configurations or performance, and include one or more central processing units 1301 and one or more memories 1302. The one or more memories 1302 store one or more program codes. The one or more program codes, when loaded and executed by the one or more processors 1301, cause the one or more processors to perform the process executed by the server in the method for displaying information provided in the above method embodiments. Certainly, the server 1300 may further include components such as a wired or wireless network interface, a keyboard, and an input/output interface, and other components for input and output. The server 1300 may further include other components configured to implement the functions of the device, which are not described herein.

In an exemplary embodiment, a computer-readable storage medium storing one or more program codes is further provided, for example, the memory 1302 storing the program code. The one or more program codes, when loaded and executed by the processors 1301 of the server 1300, cause the server to perform the above method for displaying information. In some embodiments, the computer-readable storage medium may be a read-only memory (ROM), a random-access memory (RAM), a compact disc read-only memory (CD-ROM), a magnetic tape, a floppy disc, an optical data storage device, or the like.

In an exemplary embodiment, a computer program product is further provided. The computer program product stores a computer program. The computer program, when loaded and run by a processor of an electronic device, causes the device to perform the above method for displaying information as defined above.

In some embodiments, the computer program in this embodiment of the present disclosure may be deployed on and executed by a computer device, a plurality of computer devices at a same site, or a plurality of computer devices disposed at different sites and interconnected through a communication network. The plurality of computer devices disposed at the different sites and interconnected through the communication network may form a blockchain system.

It should be appreciated that the present disclosure is not limited to the exact construction that has been described above and illustrated in the accompanying drawings, and that various modifications and changes can be made without departing from the scope thereof. The scope of the present disclosure is only limited by the appended claims.

What is claimed is:

1. A method for displaying information, applicable to a computer device, the method comprising:
receiving a video data stream for displaying a first video related to a virtual space and recommending the virtual space;
displaying the first video related to the virtual space based on the video data stream; and
displaying recommendation information of the virtual space on the first video related to the virtual space, wherein the recommendation information is determined based on a live streaming goal of the virtual space, the live streaming goal indicating an effect to be achieved by live streaming.

2. The method according to claim 1, wherein displaying the recommendation information of the virtual space on the first video related to the virtual space comprises:
displaying the recommendation information of the virtual space in the form of a card on the first video related to the virtual space; or
displaying the recommendation information of the virtual space in the form of a pop-up window on the first video related to the virtual space; or
displaying the recommendation information of the virtual space in the form of a floating layer on the first video related to the virtual space.

3. The method according to claim 1, wherein displaying the recommendation information of the virtual space on the first video related to the virtual space comprises:
displaying the recommendation information of the virtual space on the first video in response to a display duration of the first video reaching a first duration.

4. The method according to claim 1, further comprising:
displaying a second video related to the virtual space in response to a trigger operation on any region in the first video other than a region of the recommendation information, wherein the second video is acquired based on a live streaming data stream of the virtual space.

5. The method according to claim 1, wherein displaying the recommendation information of the virtual space on the first video related to the virtual space comprises:
displaying a follow control on the first video related to the virtual space in a case that the live streaming goal is to increase a degree of interest in an anchor of the virtual space, wherein the follow control is used to trigger a follow on the anchor; or
displaying a view control for a target item in the virtual space on the first video related to the virtual space in a case that the live streaming goal is to increase a quantity of viewers in the virtual space, wherein the view control is used to trigger display of the target item in the virtual space, and the target item is an item to be recommended.

6. The method according to claim 5, wherein in the case that the live streaming goal is to increase the quantity of viewers in the virtual space, the method further comprises:
displaying item information of the target item on the first video related to the virtual space, wherein the item information comprises at least one of an item picture, an item name, an item tag, an item state, and an item transaction resource, the item tag indicating a virtual resource associated with the target item, the item state indicating a state of the target item in the virtual space, and the item transaction resource indicating a transaction resource required for acquiring the target item.

7. The method according to claim 5, further comprising:
displaying the target item on an item list page provided by the virtual space in response to a trigger operation on the view control for the target item, wherein the item list page is used to display at least one item; or
displaying an associated page of the target item in the virtual space in response to a trigger operation on the view control for the target item.

8. The method according to claim 7, wherein the target item comprises at least one of a transaction-type item, a download-type item, and a consultation-type item; and the view control for the target item correspondingly comprises at least one of a transact control, a download control, and a consult control; and
displaying the associated page of the target item in the virtual space in response to the trigger operation on the view control for the target item comprises:
displaying an item transaction page for the target item in the virtual space in response to a trigger operation on the transact control for the target item, wherein the item transaction page is used for transacting the target item; or
displaying an item download page for the target item in the virtual space in response to a trigger operation on the download control for the target item, wherein the item download page is used for downloading the target item; or
displaying an information acquisition page for the target item in the virtual space in response to a trigger operation on the consult control for the target item, wherein the information acquisition page is used for acquiring information required for consulting about the target item.

9. The method according to claim 5, further comprising:
stopping displaying the view control in response to no trigger operation for the view control being detected within a second duration.

10. The method according to claim 5, wherein:
the recommendation information further comprises at least one piece of associated information of the virtual space; and
the method further comprises at least one of:
displaying an object picture of the anchor of the virtual space on the first video related to the virtual space;
displaying item prompt information on the first video related to the virtual space, wherein the item prompt information indicates an entry into the virtual space to view at least one item provided in the virtual space;
displaying activity prompt information on the first video related to the virtual space, wherein the activity prompt information indicates presence of at least one item in the virtual space participating in a target activity;
displaying resource prompt information on the first video related to the virtual space, wherein the resource prompt information indicates an item transaction resource meeting a resource quantity condition in item transaction resources of at least one item in the virtual space;
displaying first quantity prompt information on the first video related to the virtual space, wherein the first quantity prompt information indicates a quantity of at least one item posted in the virtual space;
displaying second quantity prompt information on the first video related to the virtual space, wherein the second quantity prompt information indicates a quantity of online viewers in the virtual space; and
displaying third quantity prompt information on the first video related to the virtual space, wherein the third quantity prompt information indicates a quantity of viewers having reserved an item in the virtual space.

11. The method according to claim 10, wherein said displaying the second quantity prompt information on the first video related to the virtual space comprises:
displaying the second quantity prompt information on the first video related to the virtual space in response to the quantity of online viewers in the virtual space reaching a target quantity.

12. The method according to claim 10, wherein in the case that the live streaming goal is to increase the quantity of viewers in the virtual space, the method further comprises:
displaying at least one piece of associated information of the virtual space on the first video related to the virtual space; and
switching to display the view control for the target item in response to a display duration of the at least one piece of associated information reaching a third duration.

13. A method for displaying information, applicable to a computer device, the method comprising:
acquiring a live streaming goal of a virtual space, wherein the live streaming goal indicates an effect to be achieved by live streaming;
determining recommendation information of the virtual space based on the live streaming goal of the virtual space; and
sending a video data stream of the virtual space to a terminal, wherein the video data stream carries the recommendation information, to trigger the terminal, based on the video data stream, to display a first video related to the virtual space and display the recommendation information of the virtual space on the first video related to the virtual space, the video data stream being used for recommending the virtual space.

14. The method according to claim 13, wherein acquiring the live streaming goal of the virtual space comprises:
acquiring, based on a space identifier of the virtual space, a live streaming goal corresponding to the space identifier from first relationship data, and determining the acquired live streaming goal as the live streaming goal of the virtual space, wherein the first relationship data indicates a corresponding relationship between the space identifier and the live streaming goal; or
acquiring the live streaming goal of the virtual space by performing image recognition on a second video related to the virtual space, wherein the second video is acquired based on a live streaming data stream of the virtual space.

15. The method according to claim 13, wherein determining the recommendation information of the virtual space based on the live streaming goal of the virtual space comprises:
acquiring, based on the live streaming goal of the virtual space, an information type corresponding to the live streaming goal from second relationship data, wherein the information type indicates a type of recommendation information to be determined, and the second relationship data indicates a corresponding relationship between the live streaming goal and the information type; and
acquiring recommendation information of the acquired information type of the virtual space.

16. The method according to claim 13, further comprising:
sending a live streaming data stream of the virtual space to the terminal in response to an image display request from the terminal, to trigger the terminal to display a second video related to the virtual space, wherein the image display request is sent in response to a trigger operation on any region in the first video other than a region of the recommendation information.

17. The method according to claim 13, further comprising any one of:
sending first recommendation information to the terminal in a case that the live streaming goal is to increase a degree of interest in an anchor of the virtual space, wherein the first recommendation information is to display a follow control on the first video related to the virtual space, the follow control being used to trigger a follow on the anchor of the virtual space; and
sending second recommendation information to the terminal in a case that the live streaming goal is to increase a quantity of viewers in the virtual space, wherein the second recommendation information is to display a view control for a target item in the virtual space on the first video related to the virtual space, the view control being used to trigger display of the target item in the virtual space, and the target item being an item to be recommended.

18. The method according to claim 17, further comprising:
acquiring, from at least one item provided in the virtual space, at least one of an item matching with an object logged in to the terminal, an item being introduced in the virtual space, and an item meeting a target condition in the virtual space; and determining the acquired item as the target item.

19. The method according to claim 17, further comprising any one of:
sending a live streaming data stream of the virtual space and an item list page provided by the virtual space to the terminal in response to a first object display request from the terminal, to trigger the terminal to display the target item on the item list page provided by the virtual space, wherein the item list page is used to display at least one item, and the first object display request is sent in response to a trigger operation on the view control for the target item; and
sending the live streaming data stream of the virtual space and an associated page of the target item to the terminal in response to a second object display request from the terminal, to trigger the terminal to display the associated page of the target item in the virtual space, wherein the second object display request is sent in response to a trigger operation on the view control for the target item.

20. A computer device, comprising:
one or more processors; and
a memory configured to store one or more program codes executable by the one or more processors,
wherein the one or more processors, when loading and executing the one or more program codes, are configured to:
receive a video data stream for displaying a first video related to a virtual space and recommending the virtual space;
display the first video related to the virtual space based on the video data stream; and
display recommendation information of the virtual space on the first video related to the virtual space, wherein the recommendation information is determined based on a live streaming goal of the virtual space, the live streaming goal indicating an effect to be achieved by live streaming.
